(19) United States
(12) Patent Application Publication
(10) Pub. No.: US 2026/0247390 A1
(43) Pub. Date: Aug. 20, 2026

(54) INDICATION OF UNUSED TRANSMISSION OCCASIONS

(71) Applicant: Lenovo (Singapore) Pte. Limited, Singapore (SG)

(72) Inventors: Hossein Bagheri, Urbana, IL (US); Vijay Nangia, Woodridge, IL (US); Joachim Löhr, Wiesbaden (DE)

(73) Assignee: Lenovo (Singapore) Pte. Limited, Singapore (SG)

(21) Appl. No.: 19/469,512

(22) PCT Filed: Mar. 28, 2024
(86) PCT No.: PCT/IB2024/053058

§ 371 Date: Sep. 26, 2025

Related U.S. Application Data
(60) Provisional application No. 63/493,368, filed on Mar. 31, 2023.

(51) Int. Cl. H04W 72/21

(52) U.S. Cl. CPC H04W 72/21

(57) ABSTRACT

Various aspects of the present disclosure support indication of unused transmission occasions. For instance, implementations provide techniques in which uplink control information (UCI) size can be fixed over multiple slots, and in later slots information about earlier slots can be provided. In implementations a UCI multiplexed with an uplink transmission associated with a configured grant (CG) configuration can indicate unused CG occasions of the CG configuration. For instance, determination of content of individual UCI can be provided based on codepoints configured per CG occasion and/or slot in which the UCI is sent in. Further, the described techniques provide for downlink control information (DCI) scheduling a retransmission of a CG physical uplink shared channel (PUSCH) which collides with a physical uplink control channel (PUCCH) and indicates whether the hybrid automatic repeat request acknowledgement (HARQ-ACK) of the PUCCH can be multiplexed in the retransmission of the CG-PUSCH.

### RELATED APPLICATION

This application claims priority to U.S. Provisional Application Ser. No. 63/493,368 filed Mar. 31, 2023, entitled “INDICATION OF UNUSED TRANSMISSION OCCASIONS,” the disclosure of which is incorporated by reference herein in its entirety.

### TECHNICAL FIELD

The present disclosure relates to wireless communications, and more specifically to management of transmission occasions in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some proposals discuss ways for identifying status of different CG resources, such as whether configured grant (CG) resources of a UE are used or unused for transmission by the UE. Such proposals, however, may be inefficient and/or unable to adapt to changes in the size of data to be transmitted over CG resources.

### SUMMARY

The present disclosure relates to methods, apparatuses, and systems that support indication of unused transmission occasions. For instance, implementations provide techniques in which uplink control information (UCI) size can be fixed over multiple slots, and in later slots information about earlier slots can be provided. In implementations a UCI multiplexed with an uplink transmission associated with a CG configuration can indicate unused CG occasions of the CG configuration. The UCI, for instance, can indicate whether CG occasions within a time unit are unused. Accordingly, this disclosure provides details of UCI indications when the UCI is transmitted in multiple CG physical uplink shared channel (PUSCH) occasions. In particular, the described techniques provide for determination of content of individual UCI such as based on codepoints configured per CG occasion and/or slot in which the UCI is sent in. For instance, the codepoints may include unused CG occasions and/or slots prior to transmission of the UCI and the UCI may provide consistent information. Further, the described techniques provide for downlink control information (DCI) scheduling a retransmission of a CG-PUSCH which collides with a physical uplink control channel (PUCCH) and indicate whether the hybrid automatic repeat request acknowledgement (HARQ-ACK) of the PUCCH can be multiplexed in the retransmission of the CG-PUSCH.

By utilizing the described techniques, data transmission latency is reduced and efficient utilization of wireless resources (e.g., CG resources) is increased.

Some implementations of the methods and apparatuses described herein may further include receiving, at an apparatus, one or more codepoint configurations indicating codepoints for identifying used slots and unused slots; generating, based at least in part on a codepoint configuration of the one or more codepoint configurations, one or more codepoint indications including codepoints for a set of slots, the set of slots including a first subset of one or more unused slots and a second subset of one or more used slots, two or more slots of the set of slots having different codepoints, and at least one codepoint for a first slot indicating that a second slot before the first slot is unused; and transmitting one or more UCI via the second subset of one or more used slots, the one or more UCI including the one or more codepoint indications.

Some implementations of the methods and apparatuses described herein may further include: where the first subset of one or more slots includes one or more slots where CG PUSCH transmission does not occur, and the second subset of one or more slots includes one or more slots where CG-PUSCH transmission occurs; further including preventing a condition where a first UCI after the second slot identifies the second slot as unused and a second UCI after the second slot identifies the second slot as used; the one or more codepoint configurations include multiple codepoint configurations, and the method further includes selecting the codepoint configuration from the multiple codepoint configurations based at least in part on a traffic condition of the set of slots; the traffic condition includes a traffic pattern associated with the set of slots, and the method further includes causing the apparatus to determine, based at least in part on the traffic pattern, the second subset of one more used slots are to be used for CG PUSCH transmission; the method further includes transmitting, to a network entity, a UCI including an indication of the codepoint configuration selected from the multiple codepoint configurations; each codepoint configuration of the multiple codepoint configurations is associated with a table including rows, and each row includes a mapping of a codepoint to unused slot indices associated with a UCI transmission in a particular slot.

Some implementations of the methods and apparatuses described herein may further include receiving a first DCI scheduling a downlink transmission; determining a PUCCH resource for transmission of HARQ-ACK in response to the first DCI; determining that the PUCCH resource overlaps in time with a first CG PUSCH occasion of a slot of the set of slots; determining that the HARQ-ACK is to be multiplexed with a first CG-PUSCH transmission in the first CG PUSCH occasion; transmitting the first CG-PUSCH in the first slot; transmitting a second CG-PUSCH in a second CG PUSCH occasion in a third slot, the third slot is after the first slot, and the second CG-PUSCH includes a UCI indicating a codepoint associated with the first subset of one or more unused slots; and receiving a second DCI scheduling a retransmission of the first CG-PUSCH; the second DCI indicates the HARQ-ACK to be multiplexed with the retransmission of the first CG-PUSCH; if the apparatus does not receive a third DCI scheduling a retransmission of a downlink transmission associated with the HARQ-ACK prior to reception of the second DCI and after the second CG-PUSCH, the method further includes multiplexing the HARQ-ACK to the retransmission of the first CG-PUSCH.

Some implementations of the methods and apparatuses described herein may further include: transmitting, by an apparatus, one or more codepoint configurations indicating codepoints for identifying used slots and unused slots, each codepoint indicating a subset of one or more slots that are unused, two or more slots of the codepoint configuration having different codepoints, and at least one codepoint in the codepoint configuration for a first slot indicating that a second slot before the first slot is unused; and receiving UCI in a slot of a set of slots, the UCI including a codepoint indication formatted based at least in part on a codepoint configuration of the one or more codepoint configurations, a slot index associated with the UCI, and the codepoint indication identifying a subset of one or more unused slots of the set of slots.

Some implementations of the methods and apparatuses described herein may further transmitting a first DCI scheduling a downlink transmission; determining a PUCCH resource for transmission of HARQ-ACK in response to the first DCI; determining that the PUCCH resource overlaps in time with a first CG PUSCH occasion of the slot of the set of slots; determining that no PUSCH transmission is detected at the first CG-PUSCH occasion; receiving a second UCI in a second CG-PUSCH occasion of a second slot of the set of slots, the second UCI indicating that a PUSCH transmission occurred in the first CG PUSCH occasion; and transmitting a second DCI scheduling a retransmission of the first CG-PUSCH in response to the second UCI; the second DCI includes an indication of the HARQ-ACK to be multiplexed with the retransmission of the first CG-PUSCH; if the apparatus does not transmit a third DCI scheduling a retransmission of a downlink transmission associated with the HARQ-ACK prior to transmission of the second DCI and after the second CG-PUSCH, a configuration of the apparatus indicates that the HARQ-ACK is to be multiplexed into the retransmission of the first CG-PUSCH.

### BRIEF DESCRIPTION OF THE DRAWINGS

FIG. 1 illustrates an example of a wireless communications system that supports indication of unused transmission occasions in accordance with aspects of the present disclosure.

FIG. 2 illustrates a scenario for UCI indicating up to four unused PUSCH occasions.

FIG. 3 illustrates a scenario for unused CG PUSCH indication with adjustable UCI size.

FIG. 4 illustrates a scenario that supports indication of unused transmission occasions in accordance with aspects of the present disclosure.

FIG. 5 illustrates a scenario that supports indication of unused transmission occasions in accordance with aspects of the present disclosure.

FIGS. 6 and 7 illustrate examples of block diagrams of devices that support indication of unused transmission occasions in accordance with aspects of the present disclosure.

FIGS. 8 through 11 illustrate flowcharts of methods that support indication of unused transmission occasions in accordance with aspects of the present disclosure.

### DETAILED DESCRIPTION

In wireless communications systems, a UE can be provided with CG resources to transmit various types of data. Some CG resources of a CG, however, may remain unused. Thus, some proposals discuss ways for indicating (e.g., to a network entity such as a gNB) whether particular CG resources are used or unused. For instance, a proposal discusses that a UE is to use a same UCI content. A drawback to this approach is that some of the content may be already available to the gNB, e.g., if UCI is sent in slot ‘i’, the gNB may know slot ‘i’ is used as it is receiving UCI from the UE. In another proposal, UCI size is reduced as slot index increases within a time window. A drawback to this approach is that UCI size can be varying, and a UE may perform different rate-matching patterns over different slots. Thus, such an attempt at reducing UCI payload may not provide significant gain, especially given the small size (in bits) of UCI compared to the PUSCH size.

Accordingly, this disclosure provides for techniques that support indication of unused transmission occasions. For instance, implementations provide techniques in which UCI size can be fixed over multiple slots, and in later slots information about earlier slots can be provided. In implementations a UCI multiplexed with an uplink transmission associated with a CG configuration can indicate unused CG occasions of the CG configuration. The UCI, for instance, can indicate whether CG occasions within a time unit are unused. Accordingly, this disclosure provides details of UCI indications when the UCI is transmitted in multiple CG PUSCH occasions. In particular, the described techniques provide for determination of content of individual UCI such as based on codepoints configured per CG occasion and/or slot in which the UCI is sent in. For instance, the codepoints may include unused CG occasions and/or slots prior to transmission of the UCI and the UCI may provide consistent information. Further, the described techniques provide for DCI scheduling a retransmission of a CG-PUSCH which collides with a PUCCH and indicate whether the HARQ-ACK of the PUCCH can be multiplexed in the retransmission of the CG-PUSCH.

Thus, by utilizing the described techniques, data transmission latency is reduced and efficient utilization of wireless resources (e.g., CG resources) is increased. For instance, the described techniques enable a gNB to perform faster uplink retransmissions, such as in scenarios where discontinuous transmission (DTX) detection of a CG PUSCH occasion occurs.

Aspects of the present disclosure are described in the context of a wireless communications system. Aspects of the present disclosure are further illustrated and described with reference to device diagrams and flowcharts.

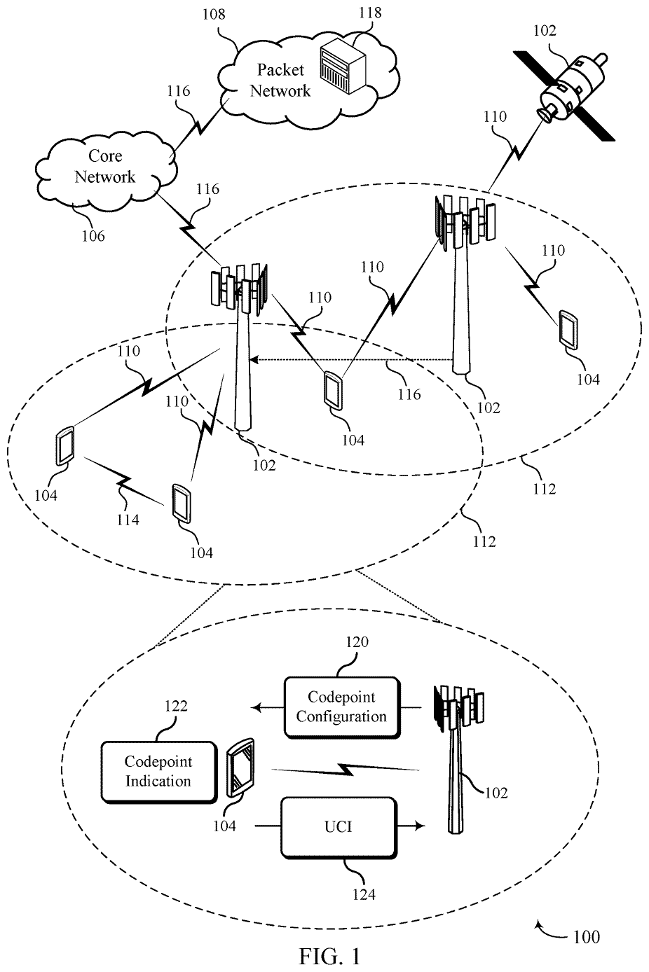

FIG. 1 illustrates an example of a wireless communications system 100 that supports indication of unused transmission occasions in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHZ-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for indication of unused transmission occasions, a network entity 102 (e.g., gNB) generates a codepoint configuration 120 and transmits the codepoint configuration 120 to a UE 104. The codepoint configuration 120, for instance, indicates codepoints for identifying used slots and unused slots of CG resources. The UE 104 receives the codepoint configuration 120 and generates a codepoint indication 122 based at least in part on the codepoint configuration 120. The codepoint indication 122, for instance, includes codepoints for a set of slots that include a first subset of one or more unused slots and a second subset of one or more used slots. Further, two or more slots of the set of slots have different codepoints and at least one codepoint for a first slot indicates that a second slot before the first slot is unused. The UE 104 transmits UCI 124 including the codepoint indication 122 to the network entity 102 and the network entity 102 can identify used and unused CG resources (e.g., used and unused transmission occasions) indicated in the UCI. In implementations the UCI 124 can include multiple different instances of UCI each with its own particular codepoint indication 122 configuration.

As discussed in Technical Specification (TS) 38.300, uplink data transmission (e.g., PUSCH) may be scheduled with DCI on physical downlink control channel (PDCCH), or a semi-static configured grant may be provided over RRC, where two types of operation are supported:
The first PUSCH is triggered with a DCI, with subsequent PUSCH transmissions following the RRC configuration and scheduling received on the DCI, or
The PUSCH is triggered by data arrival to the UE's transmit buffer and the PUSCH transmissions follow the RRC configuration.

For configured grants operation with shared spectrum channel access, a CG-UCI (Configured Grant Uplink Control Information) can be transmitted in PUSCH scheduled by configured uplink grant.

Large video frame sizes may require more than one PUSCH occasion to be transmitted. For instance, 1~5 PUSCHs per video frame may be used depending on the channel condition and the video frame size. One way is to configure multiple PUSCH occasions within a CG period.

Consider, for instance, TS 38.214 Clause 6.1.2.3 which discusses resource allocation for uplink transmission with configured grant:

A set of allowed periodicities P are defined in TS 38.331. The higher layer parameter cg-nrofSlots provides the number of consecutive slots allocated within a configured grant period. The higher layer parameter cg-nrofPUSCH-InSlot provides the number of consecutive PUSCH allocations within a slot, where the first PUSCH allocation follows the higher layer parameter timeDomainAllocation for Type 1 PUSCH transmission or the higher layer configuration according to TS 38.321, and uplink (UL) grant received on the DCI for Type 2 PUSCH transmissions, and the remaining PUSCH allocations have the same length and PUSCH mapping type, and are appended following the previous allocations without any gaps. The same combination of start symbol and length and PUSCH mapping type repeats over the consecutively allocated slots.

Some proposals discuss that the CG resource, however, is semi-statically configured, and cannot adapt to the varying size of video frames such as the ones associated with extended reality such as virtual reality and or augmented reality. If the number of configured resources is not sufficient for transmission of a video frame, some scheduling delay associated with the dynamic scheduling could occur for scheduling the rest of the video frame that could not be fit in the configured resources.

In order to avoid the extra delay caused by additional dynamic scheduling, the CG resource within one CG period could be configured according to a relatively large size for transmission of a video frame. Upon arrival of the video frame at UE's buffer, the UE can determine how much resource out of the configured resources within one CG period is needed and could indicate the unused amount of resources to gNB so that gNB could schedule other UL transmissions (e.g., for the same UE or a different UE) in at least some of the unused resources. The indication could be via UCI or MAC control element (CE) and could be transmitted in the first CG PUSCH occasion. Note that the indication could potentially indicate unused CG occasions/resources associated with multiple configured configurations, e.g., in one CG period or in multiple CG periods.

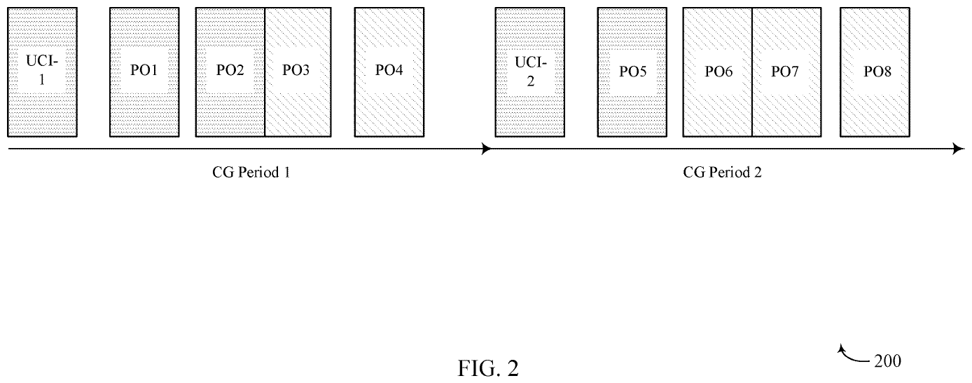

Some proposals pertain to indications of unused transmission occasions within one period of a CG configuration. For instance, FIG. 2 illustrates a scenario 200 for UCI indicating up to four unused PUSCH occasions. In a first UCI within CG period 1, the UE can indicate unused PUSCH occasions (PO) PO3 and PO4 out of PO1-PO4, whereas in a second UCI within CG period 2, the UE can indicate unused PUSCH occasions PO6, PO7, and PO8 out of PO5-PO8.

Some proposals discuss that a UCI in a CG transmission occasion of a CG configuration indicate unused transmission occasions of that CG configuration within one period of the CG configuration (e.g., as illustrated in the scenario 200). In contrast, this disclosure provides content of the UCI in case the UCI indicating unused CG occasions is transmitted multiple times within a time duration such as within a period of a CG configuration.

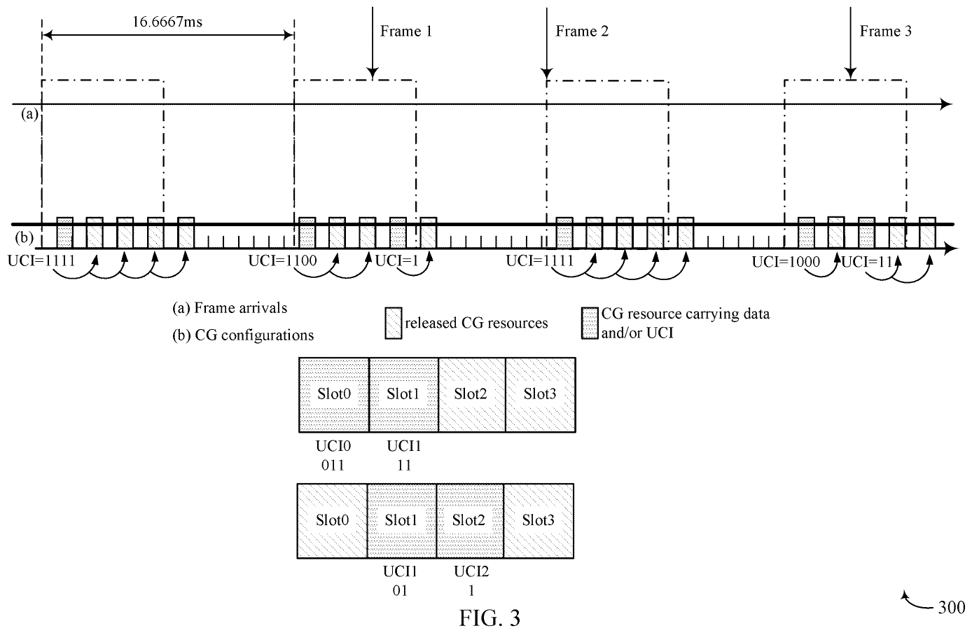

FIG. 3 illustrates a scenario 300 for unused CG PUSCH indication with adjustable UCI size. Each bit in each UCI indicates the corresponding next CG occasion is unused if set to ‘1’ and used if set to ‘0’. UCI0 includes 3 bits corresponding to next 3 CG occasions, whereas UCI1 includes 2 bits corresponding to next 2 CG occasions. The scenario 300, for instance, illustrates an example proposal to reduce the size of UCI in case of multiple UCI transmission within a time window. In other proposals, a two-stage UCI indication is discussed: e.g. a part-1 UCI with 1 bit flag is present along with each CG PUSCH, and the 1 bit flag indicates whether part-2 CG-UCI is present. If present, part-2 CG-UCI indicates detailed information of unused CG occasions.

This disclosure, however, proposes to keep the size of UCI fixed and instead provide used and unused information about previous CG occasions. Further, this disclosure proposes to have multiple lookup tables (e.g., 2 lookup tables) for states of UCI indication, and part-1 UCI is present along with each CG PUSCH and indicates which lookup table is used in part-2 CG-UCI.

In this disclosure: CG transmission occasions, CG resources, and PUSCH occasions can be used interchangeably; a slot can include one or multiple CG occasions; UCI indicating unused CG occasions can be a new UCI or a CG-UCI (e.g., modified CG-UCI such as CG-UCI with new fields appended or some fields re-purposed); and the terms slots, time unit, and group of symbols can be used interchangeably.

Implementations can provide for UCI indication in multiple transmitted PO. For instance, a UE can be configured to indicate unused CG PUSCH occasions in ‘m’ slots and/or unused CG PUSCH occasions from a reference time. The UE can then determine unused CG PUSCH occasions of a time window ‘W’ and determine a set of CG PUSCH occasions of ‘W’, referred to as ‘S’, and the UE can transmit UCI indicating unused CG PUSCH occasions of ‘W’. Further, for each CG PUSCH occasion of ‘S’, the UE can determine the codepoints, states, and/or bitmap for indication of unused CG PUSCH occasions based on one or more of the CG PUSCH occasion, CG PUSCH occasion group, and/or slot in which the UCI is sent, or the number of CG PUSCH occasions, CG PUSCH occasion groups, and/or slots that the indication is applicable to. The UE can then transmit UCI in CG PUSCH occasions of the time window that the UE transmits in.

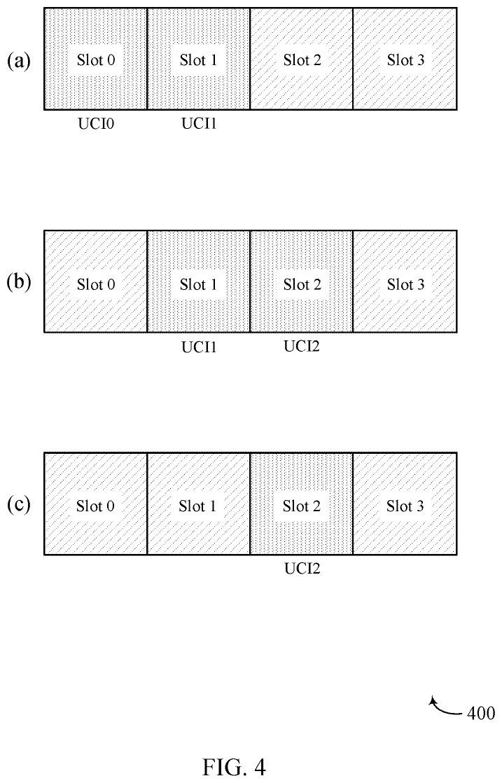

FIG. 4 illustrates a scenario 400 that supports indication of unused transmission occasions in accordance with aspects of the present disclosure. The scenario 400, for instance, illustrates an example where a time window includes ‘m’=4 slots (slot 0) and the UCI has 2 bits for indication of unused CG occasions. For example, the UE transmits UCI in all CG PUSCH occasions where CG-PUSCH is transmitted, e.g., where a transport block (TB) is to be transmitted.

In the scenario 400: (a) slots 0 and 1 are used, and slots 2 and 3 are unused; UCI can be sent in slots 0 & 1 indicating slots 2&3 are unused; (b) slots 1 and 2 are used, and slots 0 and 3 are unused; UCI is sent in slots 1 & 2 indicating slot 3 is unused; and (c) slot 2 is used, and slots 0, 1 and 3 are unused; UCI is sent in slot 1 indicating slots 0,1, and 3 are unused.

In some example implementations:

If a UCI is sent in slot 0, the codepoints are:
i. 00 (all slots are used)
ii. 01 (slot 3 is unused)
iii. 10 (slots 2, 3 are unused)
iv. 11 (slots 1, 2, 3 are unused)

If a UCI is sent in slot 1, the codepoints are:
i. 00 (all slots are used)
ii. 01 (slot 3 is unused)
iii. 10 (slots 2, 3 are unused)
iv. 11 (slots 0, 2, 3 are unused)

If a UCI is sent in slot 2, the codepoints are:
i. 00 (all slots are used)
ii. 01 (slot 3 is unused)
iii. 10 (slots 1, 3 are unused)
iv. 11 (slots 0, 1, 3 are unused)

If a UCI is sent in slot 3, the codepoints are:
i. 00 (all slots are used)
ii. 01 (slot 2 is unused)
iii. 10 (slots 1, 2 are unused)
iv. 11 (slots 0, 1, 2 are unused)

Accordingly, in addition to indicating unused future CG PUSCH occasions, a gNB can benefit from a UE indicating whether previous CG occasions had CG PUSCH transmissions or they were unused. For instance, if UCI is sent in slot 1 and UCI indicates slots 2, 3 are unused, this indicates to a gNB that there was a transmission in slot 0 which the gNB did not receive and/or detect, otherwise, the UE may have indicated slots 0, 2, 3 as unused. In such scenarios, the gNB can schedule a retransmission for the TB of slot 0 faster as compared to a scenario where a retransmission timer is exceeded.

In implementations where a UCI indicates slot 3 is unused, this indicates to the gNB that there were transmissions in slot 0 and slot 2 which the gNB did not receive and/or detect, otherwise the UE may have indicated slots 0, 2, 3 are unused. In such scenarios, the gNB can schedule a retransmission for the TBs of slot 0 and 2 faster as compared to a scenario where a corresponding retransmission timer is exceeded.

In scenarios where overlap of a PUCCH carrying HARQ-ACK and a CG-PUSCH occurs, the HARQ-ACK can be multiplexed in the CG-PUSCH such as if a multiplexing timeline is satisfied. Further, if a gNB misses the CG-PUSCH carrying also HARQ-ACK (e.g., gNB detects DTX on the CG-PUSCH) and a next UCI indicates that the CG-PUSCH was not unused, such information can indicate the scenario to the gNB. For instance, without this information, the gNB may assume that the UE missed the DCI scheduling the downlink transmission(s) for which the HARQ-ACK was multiplexed in the CG-PUSCH, and the gNB may schedule retransmission of the downlink transmissions using PDCCH with a higher aggregation level (AL). The gNB may also increase modulation and coding scheme (MCS) backoff, e.g., reduce the scheduled MCS.

Further, obtaining such information can assist the gNB in performing various operations. For instance, this information can indicate to the gNB that the HARQ-ACK was multiplexed in the CG-PUSCH that was missed and/or subject to DTX. In such scenarios the gNB can schedule downlink retransmissions for the downlink transmissions corresponding to HARQ-ACK and/or reschedule the CG-PUSCH including the HARQ-ACK, e.g., if more than a threshold number of HARQ-ACK bits were missed. For instance, the gNB can indicate in the DCI scheduling retransmission of the CG-PUSCH (and/or there could be rules to determine if the HARQ-ACK should be multiplexed into the retransmission of the CG-PUSCH e.g., based on time division duplex (TDD) configuration) whether the HARQ-ACK which was multiplexed in the CG-PUSCH is to be included in the retransmission corresponding to the CG-PUSCH. Note that this feature can be quite general and can also be applicable to scheduled PUSCHs without indication of unused CG occasions. In an example, if more than a threshold number of HARQ-ACK bits were multiplexed into a PUSCH and that PUSCH was not received/detected by the gNB, the gNB can schedule a retransmission associated with that PUSCH wherein the retransmission includes the HARQ-ACK bits.

As an example rule, if there is less than a threshold amount of resources (e.g., a couple of symbols with less than a threshold number of RBs) for PDCCH transmission/monitoring in between multiple uplink slots, the UE upon reception of a PDCCH scheduling a retransmission of the CG-PUSCH can include the HARQ-ACK in the retransmission of the PUSCH. Further, an additional criterion can be applied such as if the UE has not received a DCI scheduling downlink (DL) retransmission(s) in a time window or prior to reception of a DCI scheduling retransmission of the CG-PUSCH.

In implementations, if a CG retransmission timer (e.g., enabling a UE to retransmit a transport block of a HARQ process after a timer expires) or a CG configuration timer (e.g., enabling UE to transmit a new transport block with the same HARQ process as a HARQ process corresponding to the CG-PUSCH (slot 0) after the timer expires) is running, upon reception of DCI scheduling retransmission of the CG-PUSCH of slot 0, the CG retransmission timer can be stopped and/or terminated and the CG configuration timer can be restarted.

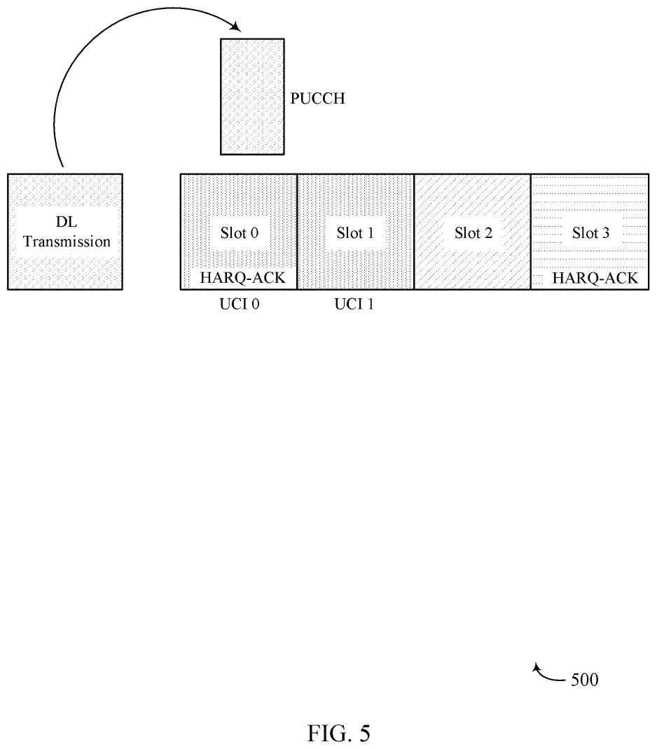

FIG. 5 illustrates a scenario 500 that supports indication of unused transmission occasions in accordance with aspects of the present disclosure. In the scenario 500, CG-PUSCH of slot 0 and PUCCH carrying HARQ-ACK of downlink transmission have collided, the HARQ-ACK of the downlink transmission was multiplexed into the CG-PUSCH of slot 0, and CG-PUSCH transmission in slot 0 was not detected by the gNB. From UCI 1, the gNB obtains information that there was a CG-PUSCH transmission in slot 0 which was missed, and thus the gNB sends a message to the UE scheduling a retransmission of the CG-PUSCH of slot 0 in slot 3. Further, the HARQ-ACK is also multiplexed into the PUSCH transmission in slot 3.

In implementations, if a UE is configured (e.g., instructed) to indicate unused CG occasions for ‘G’ CG occasions, ‘G’ groups of CG occasions, and/or ‘G’ time units via a UCI, the codepoints, states, and/or bitmap for each CG occasion in which a UCI is to be sent can be RRC configured and/or determined according to a formula/rule/pattern.

For instance, a lookup table can be configured with each row corresponding to a CG occasion index and providing a list of code-points. For instance, for 2-bit UCI indication over 4 slots, an example table can be Table 1.

TABLE 1

| UCI slot | | Unused slot |
|---|---|---|
| index | Code-point | indices |
| 0 | 00 | All slots are used |
| 0 | 01 | 2 |
| 0 | 10 | 3 |
| 0 | 11 | 2, 3 |
| 1 | 00 | All slots are used |
| 1 | 01 | 3 |
| 1 | 10 | 0 |
| 1 | 11 | 0, 3 |
| 2 | 00 | All slots are used |
| 2 | 01 | 1 |
| 2 | 10 | 0 |
| 2 | 11 | 0, 1 |
| 3 | 00 | All slots are used |
| 3 | 01 | 2 |
| 3 | 10 | 1 |
| 3 | 11 | 1, 2 |

In implementations a UE can be configured with multiple (e.g., 2 lookup tables) and different lookup tables can correspond to different numbers of UCI bits for indication of unused CG occasions and/or different numbers of slots and/or CG occasion groups. For instance, a lookup table can be associated with a 3-bit filed in the UCI as illustrated below in Table 2.

TABLE 2

| UCI slot | | |
|---|---|---|
| index | Code-point | Unused slot indices |
| 0 | 000 | All slots are used |
| 0 | 001 | 3 |
| 0 | 010 | 2 |
| 0 | 011 | 2, 3 |
| 0 | 100 | 1 |
| 0 | 101 | 1, 3 |
| 0 | 110 | 1, 2 |
| 0 | 111 | 1, 2, 3 |
| 1 | 000 | All slots are used |
| 1 | 001 | 3 |
| 1 | 010 | 2 |
| 1 | 011 | 2, 3 |
| 1 | 100 | 0 |
| 1 | 101 | 0, 3 |
| 1 | 110 | 0, 2 |
| 1 | 111 | 0, 2, 3 |
| 2 | 000 | All slots are used |
| 2 | 001 | 3 |
| 2 | 010 | 1 |
| 2 | 011 | 1, 3 |
| 2 | 100 | 0 |
| 2 | 101 | 0, 3 |
| 2 | 110 | 0, 1 |
| 2 | 111 | 0, 1, 3 |
| 3 | 000 | All slots are used |
| 3 | 001 | 2 |
| 3 | 010 | 1 |
| 3 | 011 | 1, 2 |
| 3 | 100 | 0 |
| 3 | 101 | 0, 2 |
| 3 | 110 | 0, 1 |
| 3 | 111 | 0, 1, 2 |

Table 3 illustrates another example lookup table corresponding to 1-bit UCI field.

TABLE 3

| UCI slot | | |
|---|---|---|
| index | Code-point | Unused slot indices |
| 0 | 0 | All slots are used |
| 0 | 1 | 2, 3 |
| 1 | 0 | All slots are used |
| 1 | 1 | 3 |
| 2 | 0 | All slots are used |
| 2 | 1 | 0, 1 |
| 3 | 0 | All slots are used |
| 3 | 1 | 1, 2 |

In implementations a UE in each UCI may indicate (e.g., via a 1-bit indication encoded separately) which lookup table the UE uses to indicate unused CG occasions and/or slots via the UCI. For instance, a 1-bit field indicates whether Table 3 (e.g., corresponding to the 1-bit unused CG occasion indication) above or Table 2 (e.g., corresponding to 3-bits unused CG occasion indication) is to be used.

The following discusses implementations where codepoints, states, and/or bitmap for each CG occasion in which a UCI is to be sent can be configured via RRC signaling and/or determined according to a formula/rule/pattern. For instance, the codepoints and/or states for the ‘i’th CG occasion, group, and/or time unit can be:
[{ }], [g_{G}], [g_{G}, g_{G-1}], [g_{G}, g_{G-1}, g_{G-2} ], . . . [g_{G}, g_{G-1}, g_{G-2}, . . . , g_{i+1}], [g_{G}, g_{G-1}, g_{G-2}, . . . , g_{i+1}, g_{i-1}], [g_{G}, g_{G-1}, g_{G-2}, . . . , g_{i+1}, g_{i-1}, g_{i-2}], . . . , [g_{G}, g_{G-1}, g_{G-2}, . . . , g_{i+1}, g_{i-1},g_{i-2}, . . . , g_{1}], wherein { } represents an empty set, and g_{k} represents ‘k’th CG occasion, group, and/or time unit.

In scenarios involving UCI indicating a bitmap for ‘G’ occasions and/or groups (e.g., one bit per occasion/group), the bitmap length can be less than ‘G’ bits. For instance, if bitmap length is G-1 bits, the UCI can indicate whether each occasion and/or group of ‘G’ occasions and/or groups excluding the occasion/group in which this particular UCI is being transmitted is unused. For example, where there are ‘G’=8 occasions, a UCI transmitted in occasion 3 can indicate a bitmap of 7 bits indicating whether other CG occasions are unused.

In implementations the UCI content over set ‘S’ is to be consistent unless the UE is configured to provide a UCI (e.g., first UCI) overriding a previous UCI (e.g., second UCI) indication, where the UCIs can provide information of unused CG occasions within a time duration. If overriding of unused CG occasions is supported, configured, and/or enabled, information regarding unused CG occasions of past CG occasions is to be consistent. For instance, the UE is not to indicate in UCI sent in slot ‘n’ that all CG occasions are used while the UCI of slot n-1 indicates slot ‘0’ was unused. For instance, in implementations the following scenario is not to occur: UCI sent in slot 1 indicates codepoint ‘11’, e.g., slots 0, 2, 3 are unused; and UCI sent in slot 2, indicates the codepoint ‘00’, e.g., all slots are used.

In implementations a reference time can be the beginning of a CG period or a beginning of a CG period that is determined based on an RRC parameter. For instance, the network can specify that a UCI is to indicate unused CG occasions of 2 CG periods; in such scenarios the reference time can be the beginning of every other CG period.

In implementations a first UCI or a part of the first UCI indicating the unused CG occasions may be omitted due to a PUSCH cancellation indication, overlap with downlink symbols, and/or limitations of UCI multiplexing, e.g., when HARQ-ACK, channel state information (CSI), and unused CG occasion indication are to be multiplexed in a CG-PUSCH. In such scenarios the UE can be allowed to override the omitted unused indication in a second UCI, where the second UCI is transmitted after the first UCI. In implementations, if a first UCI indicates a CG occasion is unused, a subsequent UCI (e.g., second UCI) may be constrained to indicate that the CG occasion is to be used only if the time gap between the first UCI and second UCI is not larger than a threshold time.

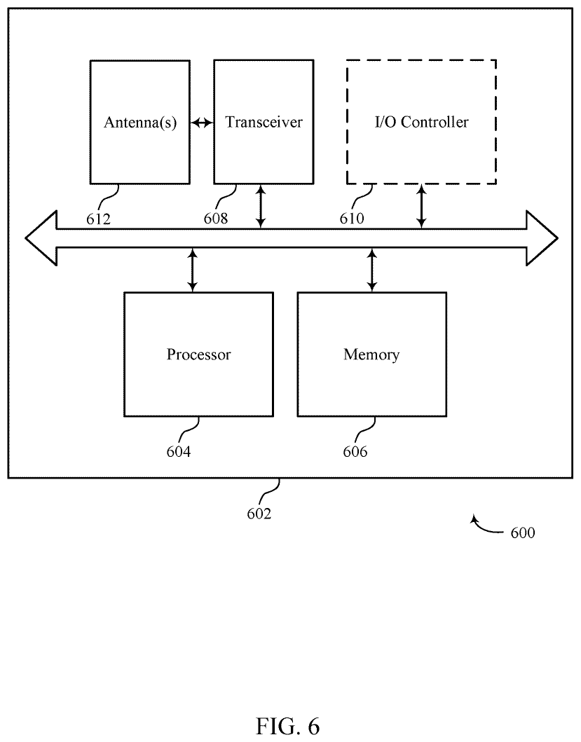

FIG. 6 illustrates an example of a block diagram 600 of a device 602 (e.g., an apparatus) that supports indication of unused transmission occasions in accordance with aspects of the present disclosure. The device 602 may be an example of UE 104 as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606). In the context of UE 104, for example, the transceiver 608 and the processor coupled 604 coupled to the transceiver 608 are configured to cause the UE 104 to perform the various described operations and/or combinations thereof.

For example, the processor 604 and/or the transceiver 608 may support wireless communication at the device 602 in accordance with examples as disclosed herein. For instance, the processor 604 and/or the transceiver 608 may be configured as and/or otherwise support a means to receive one or more codepoint configurations indicating codepoints for identifying used slots and unused slots; generate, based at least in part on a codepoint configuration of the one or more codepoint configurations, one or more codepoint indications including codepoints for a set of slots, the set of slots including a first subset of one or more unused slots and a second subset of one or more used slots, two or more slots of the set of slots having different codepoints, and at least one codepoint for a first slot indicating that a second slot before the first slot is unused; and transmit one or more UCI via the second subset of one or more used slots, the one or more UCI including the one or more codepoint indications.

Further, in some implementations, the first subset of one or more slots includes one or more slots where CG PUSCH transmission does not occur, and the second subset of one or more slots includes one or more slots where CG-PUSCH transmission occurs; the processor is configured to cause the apparatus to prevent a condition where a first UCI after the second slot identifies the second slot as unused and a second UCI after the second slot identifies the second slot as used; the one or more codepoint configurations include multiple codepoint configurations, and the processor is configured to cause the apparatus to select the codepoint configuration from the multiple codepoint configurations based at least in part on a traffic condition of the set of slots; the traffic condition includes a traffic pattern associated with the set of slots, and wherein the processor is configured to cause the apparatus to determine, based at least in part on the traffic pattern, the second subset of one more used slots are to be used for CG PUSCH transmission.

Further, in some implementations, the processor is configured to cause the apparatus to transmit, to a network entity, a UCI including an indication of the codepoint configuration selected from the multiple codepoint configurations; each codepoint configuration of the multiple codepoint configurations is associated with a table including rows, and each row includes a mapping of a codepoint to unused slot indices associated with a UCI transmission in a particular slot; the processor is configured to cause the apparatus to: receive a first DCI scheduling a downlink transmission; determine a PUCCH resource for transmission of HARQ-ACK in response to the first DCI; determine that the PUCCH resource overlaps in time with a first CG PUSCH occasion of a slot of the set of slots; determine that the HARQ-ACK is to be multiplexed with a first CG-PUSCH transmission in the first CG PUSCH occasion; transmit the first CG-PUSCH in the first slot; transmit a second CG-PUSCH in a second CG PUSCH occasion in a third slot, wherein the third slot is after the first slot, and the second CG-PUSCH includes a UCI indicating a codepoint associated with the first subset of one or more unused slots; and receive a second DCI scheduling a retransmission of the first CG-PUSCH.

Further, in some implementations, the second DCI indicates the HARQ-ACK to be multiplexed with the retransmission of the first CG-PUSCH; if the apparatus does not receive a third DCI scheduling a retransmission of a downlink transmission associated with the HARQ-ACK prior to reception of the second DCI and after the second CG-PUSCH, the processor is configured to cause the apparatus to multiplex the HARQ-ACK to the retransmission of the first CG-PUSCH.

In a further example, the processor 604 and/or the transceiver 608 may support wireless communication at the device 602 in accordance with examples as disclosed herein. The processor 604 and/or the transceiver 608, for instance, may be configured as or otherwise support a means for receiving, at an apparatus, one or more codepoint configurations indicating codepoints for identifying used slots and unused slots; generating, based at least in part on a codepoint configuration of the one or more codepoint configurations, one or more codepoint indications including codepoints for a set of slots, the set of slots including a first subset of one or more unused slots and a second subset of one or more used slots, two or more slots of the set of slots having different codepoints, and at least one codepoint for a first slot indicating that a second slot before the first slot is unused; and transmitting one or more UCI via the second subset of one or more used slots, the one or more UCI including the one or more codepoint indications

Further, in some implementations, the first subset of one or more slots includes one or more slots where CG PUSCH transmission does not occur, and the second subset of one or more slots includes one or more slots where CG-PUSCH transmission occurs; further including preventing a condition where a first UCI after the second slot identifies the second slot as unused and a second UCI after the second slot identifies the second slot as used; the one or more codepoint configurations include multiple codepoint configurations, and the method further includes selecting the codepoint configuration from the multiple codepoint configurations based at least in part on a traffic condition of the set of slots; the traffic condition includes a traffic pattern associated with the set of slots, and the method further includes causing the apparatus to determine, based at least in part on the traffic pattern, the second subset of one more used slots are to be used for CG PUSCH transmission; the method further includes transmitting, to a network entity, a UCI including an indication of the codepoint configuration selected from the multiple codepoint configurations; each codepoint configuration of the multiple codepoint configurations is associated with a table including rows, and each row includes a mapping of a codepoint to unused slot indices associated with a UCI transmission in a particular slot.

Further, in some implementations, the processor 604 and/or the transceiver 608 may be configured as or otherwise support a means for receiving a first DCI scheduling a downlink transmission; determining a PUCCH resource for transmission of HARQ-ACK in response to the first DCI; determining that the PUCCH resource overlaps in time with a first CG PUSCH occasion of a slot of the set of slots; determining that the HARQ-ACK is to be multiplexed with a first CG-PUSCH transmission in the first CG PUSCH occasion; transmitting the first CG-PUSCH in the first slot; transmitting a second CG-PUSCH in a second CG PUSCH occasion in a third slot, the third slot is after the first slot, and the second CG-PUSCH includes a UCI indicating a codepoint associated with the first subset of one or more unused slots; and receiving a second DCI scheduling a retransmission of the first CG-PUSCH; the second DCI indicates the HARQ-ACK to be multiplexed with the retransmission of the first CG-PUSCH; if the apparatus does not receive a third DCI scheduling a retransmission of a downlink transmission associated with the HARQ-ACK prior to reception of the second DCI and after the second CG-PUSCH, the method further includes multiplexing the HARQ-ACK to the retransmission of the first CG-PUSCH.

The processor 604 of the device 602, such as a UE 104, may support wireless communication in accordance with examples as disclosed herein. The processor 604 includes at least one controller coupled with at least one memory, and the at least one controller is configured to and/or operable to cause the processor to receive one or more codepoint configurations indicating codepoints for identifying used slots and unused slots; generate, based at least in part on a codepoint configuration of the one or more codepoint configurations, one or more codepoint indications comprising codepoints for a set of slots, the set of slots comprising a first subset of one or more unused slots and a second subset of one or more used slots, two or more slots of the set of slots having different codepoints, and at least one codepoint for a first slot indicating that a second slot before the first slot is unused; and transmit one or more UCI via the second subset of one or more used slots, the one or more UCI comprising the one or more codepoint indications. Further, the at least one controller is configured to and/or operable to cause the processor to perform any of the various operations described herein, such as with reference to a UE 104 and/or the device 102.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor M08. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (e.g., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

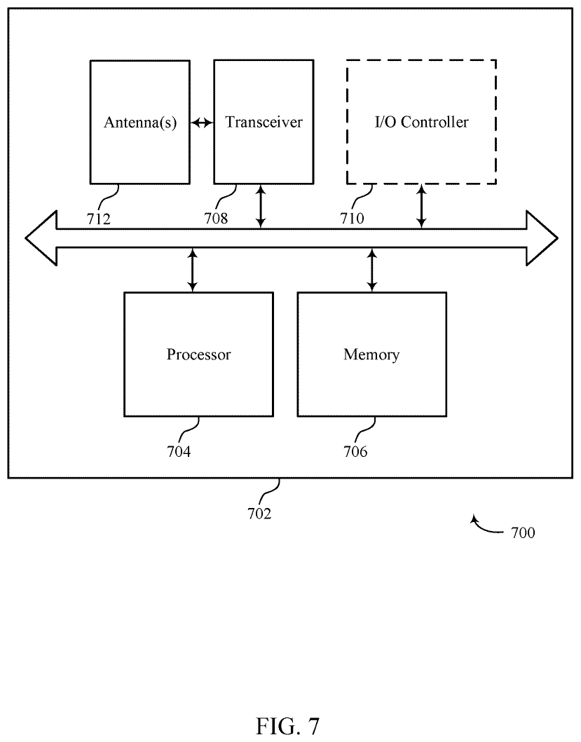

FIG. 7 illustrates an example of a block diagram 700 of a device 702 (e.g., an apparatus) that supports indication of unused transmission occasions in accordance with aspects of the present disclosure. The device 702 may be an example of a network entity 102 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706). In the context of network entity 102, for example, the transceiver 708 and the processor 704 coupled to the transceiver 708 are configured to cause the network entity 102 to perform the various described operations and/or combinations thereof.

For example, the processor 704 and/or the transceiver 708 may support wireless communication at the device 702 in accordance with examples as disclosed herein. For instance, the processor 704 and/or the transceiver 708 may be configured as or otherwise support a means to transmit one or more codepoint configurations indicating codepoints for identifying used slots and unused slots, each codepoint indicating a subset of one or more slots that are unused, two or more slots of the codepoint configuration having different codepoints, and at least one codepoint in the codepoint configuration for a first slot indicating that a second slot before the first slot is unused; and receive UCI in a slot of a set of slots, the UCI including a codepoint indication formatted based at least in part on a codepoint configuration of the one or more codepoint configurations, a slot index associated with the UCI, and the codepoint indication identifying a subset of one or more unused slots of the set of slots.

Further, in some implementations, the processor 704 and/or the transceiver 708 may be configured as or otherwise support a means to transmit a first DCI scheduling a downlink transmission; determine a PUCCH resource for transmission of HARQ-ACK in response to the first DCI; determine that the PUCCH resource overlaps in time with a first CG PUSCH occasion of the slot of the set of slots; determine that no PUSCH transmission is detected at the first CG-PUSCH occasion; receive a second UCI in a second CG-PUSCH occasion of a second slot of the set of slots, the second UCI indicating that a PUSCH transmission occurred in the first CG PUSCH occasion; and transmit a second DCI scheduling a retransmission of the first CG-PUSCH in response to the second UCI; the second DCI includes an indication of the HARQ-ACK to be multiplexed with the retransmission of the first CG-PUSCH; if the apparatus does not transmit a third DCI scheduling a retransmission of a downlink transmission associated with the HARQ-ACK prior to transmission of the second DCI and after the second CG-PUSCH, a configuration of the apparatus indicates that the HARQ-ACK is to be multiplexed into the retransmission of the first CG-PUSCH.

In a further example, the processor 704 and/or the transceiver 708 may support wireless communication at the device 702 in accordance with examples as disclosed herein. The processor 704 and/or the transceiver 708, for instance, may be configured as or otherwise support a means for transmitting, by an apparatus, one or more codepoint configurations indicating codepoints for identifying used slots and unused slots, each codepoint indicating a subset of one or more slots that are unused, two or more slots of the codepoint configuration having different codepoints, and at least one codepoint in the codepoint configuration for a first slot indicating that a second slot before the first slot is unused; and receiving UCI in a slot of a set of slots, the UCI including a codepoint indication formatted based at least in part on a codepoint configuration of the one or more codepoint configurations, a slot index associated with the UCI, and the codepoint indication identifying a subset of one or more unused slots of the set of slots.

Further, in some implementations, the processor 704 and/or the transceiver 708 may be configured as or otherwise support a means for transmitting a first DCI scheduling a downlink transmission; determining a PUCCH resource for transmission of HARQ-ACK in response to the first DCI; determining that the PUCCH resource overlaps in time with a first CG PUSCH occasion of the slot of the set of slots; determining that no PUSCH transmission is detected at the first CG-PUSCH occasion; receiving a second UCI in a second CG-PUSCH occasion of a second slot of the set of slots, the second UCI indicating that a PUSCH transmission occurred in the first CG PUSCH occasion; and transmitting a second DCI scheduling a retransmission of the first CG-PUSCH in response to the second UCI; the second DCI includes an indication of the HARQ-ACK to be multiplexed with the retransmission of the first CG-PUSCH; if the apparatus does not transmit a third DCI scheduling a retransmission of a downlink transmission associated with the HARQ-ACK prior to transmission of the second DCI and after the second CG-PUSCH, a configuration of the apparatus indicates that the HARQ-ACK is to be multiplexed into the retransmission of the first CG-PUSCH.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor M06. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (e.g., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

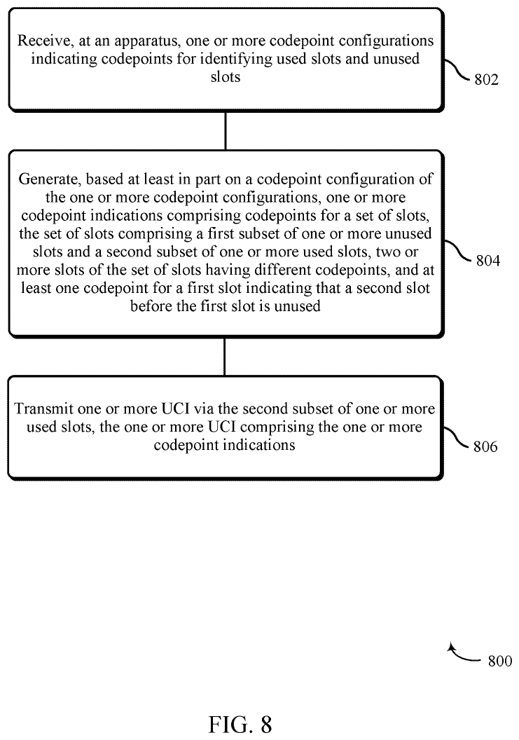

FIG. 8 illustrates a flowchart of a method 800 that supports indication of unused transmission occasions in accordance with aspects of the present disclosure. The operations of the method 800 may be implemented by a device or its components as described herein. For example, the operations of the method 800 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving, at an apparatus, one or more codepoint configurations indicating codepoints for identifying used slots and unused slots. The operations of 802 may be performed in accordance with examples as described herein. In some implementations, aspects of the operations of 802 may be performed by a device as described with reference to FIG. 1.

At 804, the method may include generating, based at least in part on a codepoint configuration of the one or more codepoint configurations, one or more codepoint indications comprising codepoints for a set of slots, the set of slots comprising a first subset of one or more unused slots and a second subset of one or more used slots, two or more slots of the set of slots having different codepoints, and at least one codepoint for a first slot indicating that a second slot before the first slot is unused. The operations of 804 may be performed in accordance with examples as described herein. In some implementations, aspects of the operations of 804 may be performed by a device as described with reference to FIG. 1.

At 806, the method may include transmitting one or more UCI via the second subset of one or more used slots, the one or more UCI comprising the one or more codepoint indications. The operations of 806 may be performed in accordance with examples as described herein. In some implementations, aspects of the operations of 806 may be performed by a device as described with reference to FIG. 1.

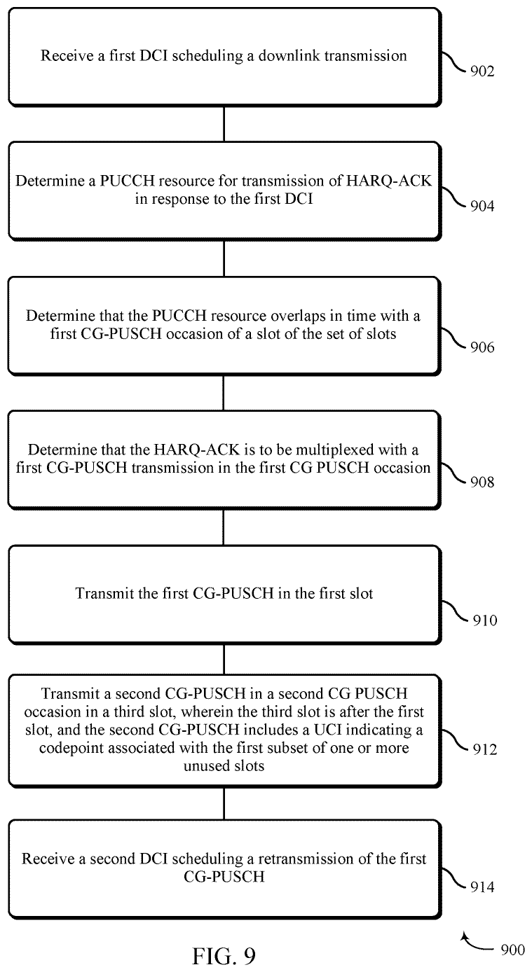

FIG. 9 illustrates a flowchart of a method 900 that supports indication of unused transmission occasions in accordance with aspects of the present disclosure. The operations of the method 900 may be implemented by a device or its components as described herein. For example, the operations of the method 900 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include receiving a first DCI scheduling a downlink transmission. The operations of 902 may be performed in accordance with examples as described herein. In some implementations, aspects of the operations of 902 may be performed by a device as described with reference to FIG. 1.

At 904, the method may include determining a PUCCH resource for transmission of HARQ-ACK in response to the first DCI. The operations of 904 may be performed in accordance with examples as described herein. In some implementations, aspects of the operations of 904 may be performed by a device as described with reference to FIG. 1.

At 906, the method may include determining that the PUCCH resource overlaps in time with a first CG-PUSCH occasion of a slot of the set of slots. The operations of 906 may be performed in accordance with examples as described herein. In some implementations, aspects of the operations of 906 may be performed by a device as described with reference to FIG. 1.

At 908, the method may include determining that the HARQ-ACK is to be multiplexed with a first CG-PUSCH transmission in the first CG PUSCH occasion. The operations of 908 may be performed in accordance with examples as described herein. In some implementations, aspects of the operations of 908 may be performed by a device as described with reference to FIG. 1.

At 910, the method may include transmitting the first CG-PUSCH in the first slot. The operations of 910 may be performed in accordance with examples as described herein. In some implementations, aspects of the operations of 910 may be performed by a device as described with reference to FIG. 1.

At 912, the method may include transmitting a second CG-PUSCH in a second CG PUSCH occasion in a third slot, wherein the third slot is after the first slot, and the second CG-PUSCH includes a UCI indicating a codepoint associated with the first subset of one or more unused slots. The operations of 912 may be performed in accordance with examples as described herein. In some implementations, aspects of the operations of 912 may be performed by a device as described with reference to FIG. 1.

At 914, the method may include receiving a second DCI scheduling a retransmission of the first CG-PUSCH. The operations of 914 may be performed in accordance with examples as described herein. In some implementations, aspects of the operations of 914 may be performed by a device as described with reference to FIG. 1.

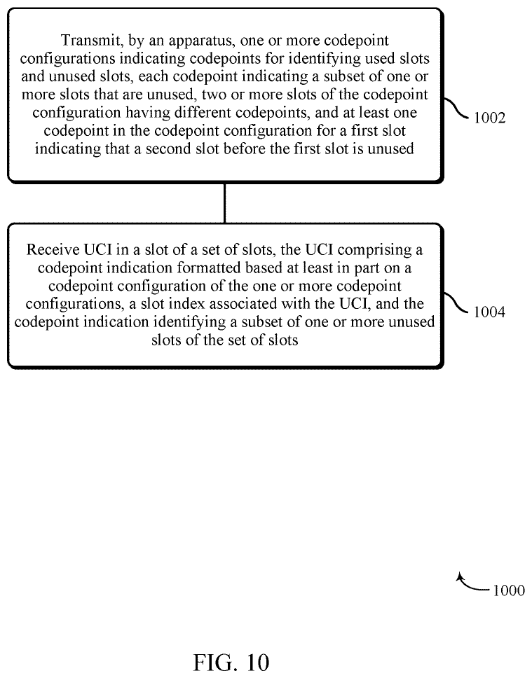

FIG. 10 illustrates a flowchart of a method 1000 that supports indication of unused transmission occasions in accordance with aspects of the present disclosure. The operations of the method 1000 may be implemented by a device or its components as described herein. For example, the operations of the method 1000 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include transmitting, by an apparatus, one or more codepoint configurations indicating codepoints for identifying used slots and unused slots, each codepoint indicating a subset of one or more slots that are unused, two or more slots of the codepoint configuration having different codepoints, and at least one codepoint in the codepoint configuration for a first slot indicating that a second slot before the first slot is unused. The operations of 1002 may be performed in accordance with examples as described herein. In some implementations, aspects of the operations of 1002 may be performed by a device as described with reference to FIG. 1.

At 1004, the method may include receiving UCI in a slot of a set of slots, the UCI comprising a codepoint indication formatted based at least in part on a codepoint configuration of the one or more codepoint configurations, a slot index associated with the UCI, and the codepoint indication identifying a subset of one or more unused slots of the set of slots. The operations of 1004 may be performed in accordance with examples as described herein. In some implementations, aspects of the operations of 1004 may be performed by a device as described with reference to FIG. 1.

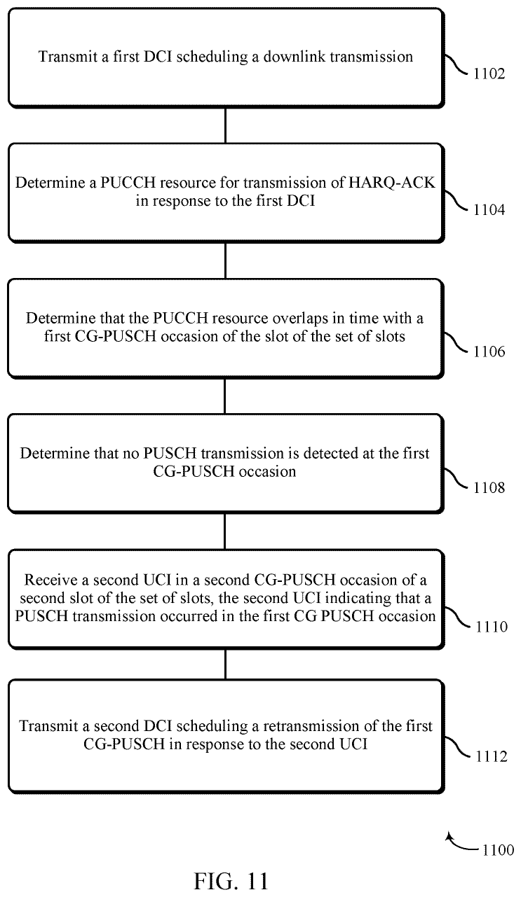

FIG. 11 illustrates a flowchart of a method 1100 that supports indication of unused transmission occasions in accordance with aspects of the present disclosure. The operations of the method 1100 may be implemented by a device or its components as described herein. For example, the operations of the method 1100 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1102, the method may include transmitting a first DCI scheduling a downlink transmission. The operations of 1102 may be performed in accordance with examples as described herein. In some implementations, aspects of the operations of 1102 may be performed by a device as described with reference to FIG. 1.

At 1104, the method may include determining a PUCCH resource for transmission of HARQ-ACK in response to the first DCI. The operations of 1104 may be performed in accordance with examples as described herein. In some implementations, aspects of the operations of 1104 may be performed by a device as described with reference to FIG. 1.

At 1106, the method may include determining that the PUCCH resource overlaps in time with a first CG-PUSCH occasion of the slot of the set of slots. The operations of 1106 may be performed in accordance with examples as described herein. In some implementations, aspects of the operations of 1106 may be performed by a device as described with reference to FIG. 1.

At 1108, the method may include determining that no PUSCH transmission is detected at the first CG-PUSCH occasion. The operations of 1108 may be performed in accordance with examples as described herein. In some implementations, aspects of the operations of 1108 may be performed by a device as described with reference to FIG. 1.

At 1110, the method may include receiving a second UCI in a second CG-PUSCH occasion of a second slot of the set of slots, the second UCI indicating that a PUSCH transmission occurred in the first CG PUSCH occasion. The operations of 1110 may be performed in accordance with examples as described herein. In some implementations, aspects of the operations of 1110 may be performed by a device as described with reference to FIG. 1.

At 1112, the method may include transmitting a second DCI scheduling a retransmission of the first CG-PUSCH in response to the second UCI. The operations of 1112 may be performed in accordance with examples as described herein. In some implementations, aspects of the operations of 1112 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive one or more codepoint configurations indicating codepoints for identifying used slots and unused slots;
generate, based at least in part on a codepoint configuration of the one or more codepoint configurations, one or more codepoint indications comprising codepoints for a set of slots, the set of slots comprising a first subset of one or more unused slots and a second subset of one or more used slots, two or more slots of the set of slots having different codepoints, and at least one codepoint for a first slot indicating that a second slot before the first slot is unused; and
transmit one or more uplink control information (UCI) via the second subset of one or more used slots, the one or more UCI comprising the one or more codepoint indications.

2. The UE of claim 1, wherein the first subset of one or more slots comprises one or more slots where configured grant (CG) physical uplink shared channel (PUSCH) transmission does not occur, and the second subset of one or more slots comprises one or more slots where CG-PUSCH transmission occurs.

3. The UE of claim 1, wherein the at least one processor is operable to cause the UE to prevent a condition where a first UCI after the second slot identifies the second slot as unused and a second UCI after the second slot identifies the second slot as used.

4. The UE of claim 1, wherein the one or more codepoint configurations comprise multiple codepoint configurations, and the at least one processor is operable to cause the UE to select the codepoint configuration from the multiple codepoint configurations based at least in part on a traffic condition of the set of slots.

5. The UE of claim 4, wherein the traffic condition comprises a traffic pattern associated with the set of slots, and the at least one processor is operable to cause the UE to determine, based at least in part on the traffic pattern, the second subset of one more used slots are to be used for configured grant (CG) physical uplink shared channel (PUSCH) transmission.

6. The UE of claim 4, wherein the at least one processor is operable to cause the UE to transmit, to a network entity, a UCI comprising an indication of the codepoint configuration selected from the multiple codepoint configurations.

7. The UE of claim 4, wherein each codepoint configuration of the multiple codepoint configurations is associated with a table comprising rows, and each row comprises a mapping of a codepoint to unused slot indices associated with a UCI transmission in a particular slot.

8. The UE of claim 1, wherein the at least one processor is operable to cause the UE to:
receive a first downlink control information (DCI) scheduling a downlink transmission;
determine a physical uplink control channel (PUCCH) resource for transmission of hybrid automatic repeat request acknowledgement (HARQ-ACK) in response to the first DCI;
determine that the PUCCH resource overlaps in time with a first configured grant (CG) physical uplink shared channel (PUSCH) occasion of a slot of the set of slots;
determine that the HARQ-ACK is to be multiplexed with a first CG-PUSCH transmission in the first CG PUSCH occasion;
transmit the first CG-PUSCH in the first slot;
transmit a second CG-PUSCH in a second CG PUSCH occasion in a third slot, wherein the third slot is after the first slot, and the second CG-PUSCH includes a UCI indicating a codepoint associated with the first subset of one or more unused slots; and
receive a second DCI scheduling a retransmission of the first CG-PUSCH.

9. The UE of claim 8, wherein the second DCI indicates the HARQ-ACK to be multiplexed with the retransmission of the first CG-PUSCH.

10. The UE of claim 8, wherein if the UE does not receive a third DCI scheduling a retransmission of a downlink transmission associated with the HARQ-ACK prior to reception of the second DCI and after the second CG-PUSCH, the at least one processor is operable to cause the UE to multiplex the HARQ-ACK to the retransmission of the first CG-PUSCH.

11. A network equipment for wireless communication, comprising:
at least one memory; and
at least one processor coupled with the at least one memory and operable to cause the network equipment to:
transmit one or more codepoint configurations indicating codepoints for identifying used slots and unused slots, each codepoint indicating a subset of one or more slots that are unused, two or more slots of the codepoint configuration having different codepoints, and at least one codepoint in the codepoint configuration for a first slot indicating that a second slot before the first slot is unused; and
receive uplink control information (UCI) in a slot of a set of slots, the UCI comprising a codepoint indication formatted based at least in part on a codepoint configuration of the one or more codepoint configurations, a slot index associated with the UCI, and the codepoint indication identifying a subset of one or more unused slots of the set of slots.

12. The network equipment of claim 11, wherein the at least one processor is operable to cause the network equipment to:
transmit a first downlink control information (DCI) scheduling a downlink transmission;
determine a physical uplink control channel (PUCCH) resource for transmission of hybrid automatic repeat request acknowledgement (HARQ-ACK) in response to the first DCI;
determine that the PUCCH resource overlaps in time with a first configured grant (CG) physical uplink shared channel (PUSCH) occasion of the slot of the set of slots;
determine that no PUSCH transmission is detected at the first CG-PUSCH occasion;
receive a second UCI in a second CG-PUSCH occasion of a second slot of the set of slots, the second UCI indicating that a PUSCH transmission occurred in the first CG PUSCH occasion; and
transmit a second DCI scheduling a retransmission of the first CG-PUSCH in response to the second UCI.

13. The network equipment of claim 12, wherein the second DCI comprises an indication of the HARQ-ACK to be multiplexed with the retransmission of the first CG-PUSCH.

14. The network equipment of claim 12, wherein if the network equipment does not transmit a third DCI scheduling a retransmission of a downlink transmission associated with the HARQ-ACK prior to transmission of the second DCI and after the second CG-PUSCH, a configuration of the network equipment indicates that the HARQ-ACK is to be multiplexed into the retransmission of the first CG-PUSCH.

15. (canceled)

16. (canceled)

17. (canceled)

18. (canceled)

19. (canceled)

20. A method performed by a user equipment (UE), the method comprising:
receiving one or more codepoint configurations indicating codepoints for identifying used slots and unused slots;
generating, based at least in part on a codepoint configuration of the one or more codepoint configurations, one or more codepoint indications comprising codepoints for a set of slots, the set of slots comprising a first subset of one or more unused slots and a second subset of one or more used slots, two or more slots of the set of slots having different codepoints, and at least one codepoint for a first slot indicating that a second slot before the first slot is unused; and
transmitting one or more uplink control information (UCI) via the second subset of one or more used slots, the one or more UCI comprising the one or more codepoint indications.

21. The method of claim 20, wherein the first subset of one or more slots comprises one or more slots where configured grant (CG) physical uplink shared channel (PUSCH) transmission does not occur, and the second subset of one or more slots comprises one or more slots where CG-PUSCH transmission occurs.

22. The method of claim 20, further comprising preventing a condition where a first UCI after the second slot identifies the second slot as unused and a second UCI after the second slot identifies the second slot as used.

23. The method of claim 20, wherein the one or more codepoint configurations comprise multiple codepoint configurations, and wherein the method further comprises selecting the codepoint configuration from the multiple codepoint configurations based at least in part on a traffic condition of the set of slots.

24. The method of claim 23, wherein the traffic condition comprises a traffic pattern associated with the set of slots, and wherein the method further comprises determining, based at least in part on the traffic pattern, the second subset of one more used slots are to be used for configured grant (CG) physical uplink shared channel (PUSCH) transmission.

25. A method performed by a network equipment, the method comprising:
transmitting one or more codepoint configurations indicating codepoints for identifying used slots and unused slots, each codepoint indicating a subset of one or more slots that are unused, two or more slots of the codepoint configuration having different codepoints, and at least one codepoint in the codepoint configuration for a first slot indicating that a second slot before the first slot is unused; and
receiving uplink control information (UCI) in a slot of a set of slots, the UCI comprising a codepoint indication formatted based at least in part on a codepoint configuration of the one or more codepoint configurations, a slot index associated with the UCI, and the codepoint indication identifying a subset of one or more unused slots of the set of slots.
